(19) United States
(12) Patent Application Publication
(10) Pub. No.: US 2011/0305505 A1
(43) Pub. Date: Dec. 15, 2011

(54) OUTDOOR EQUIPMENT

(75) Inventors: Cam Brensinger, Arlington, MA (US); Suzanne Turell, Nashua, NH (US); Ahern Laurinat, Somerville, MA (US); Barry Brensinger, Manchester, NH (US); Connie Yang, Nashua, NH (US)

(73) Assignee: NEMO EQUIPMENT, INC., Nashua, NH (US)

(21) Appl. No.: 12/920,702

(22) PCT Filed: Mar. 20, 2008
(86) PCT No.: PCT/US08/57682

§ 371 Date: May 19, 2011

Related U.S. Application Data
(60) Provisional application No. 60/895,771, filed on Mar. 20, 2007.

(51) Int. Cl. F16B 7/00

(52) U.S. Cl. 403/174

(57) ABSTRACT

Outdoor equipment including a connection joint for inflatable beams (FIG. 1), an ergonomic leave designed segmented pack (FIG. 4), a device for attachment of multiple canopy edges (FIG. 6), a stuff of sack having an integrated bleed valve (FIG. 7), an insulating tend liner (FIG. 8), a strategically cut the foam load support (FIG. 9), a dual layer sleeping pad (FIG. 14), a hand-held inflation, (FIG. 15), a tent frame with additional ridge poles (FIG. 18), an interior tent floor liner with insertion points for accessories (FIG. 23), and all weather personal hood (FIG. 25), a bending mechanism for a air beams (FIG. 28), a single wall air beam (FIG. 33), a vestibule connector (FIG. 36), a water bladder anchoring system (FIG. 37), a cross frame is suspension system (FIG. 39) and a forked bivy end (FIG. 42).

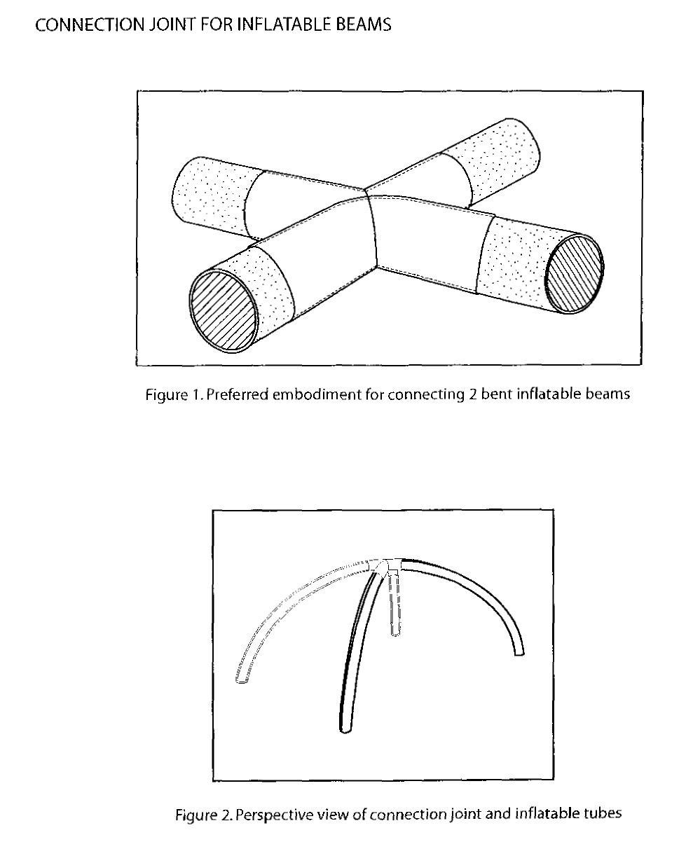

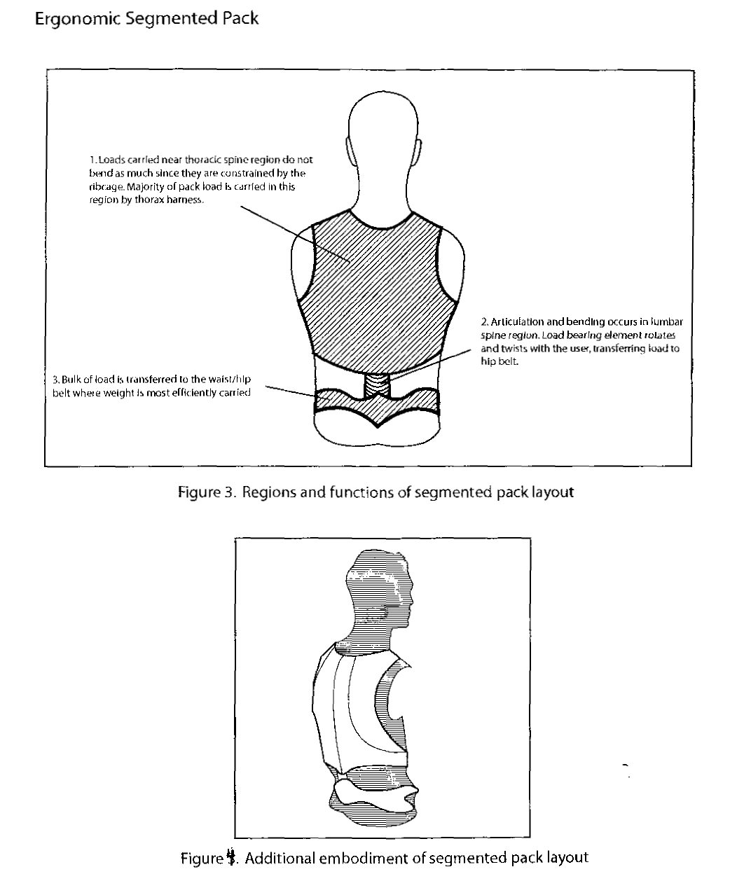

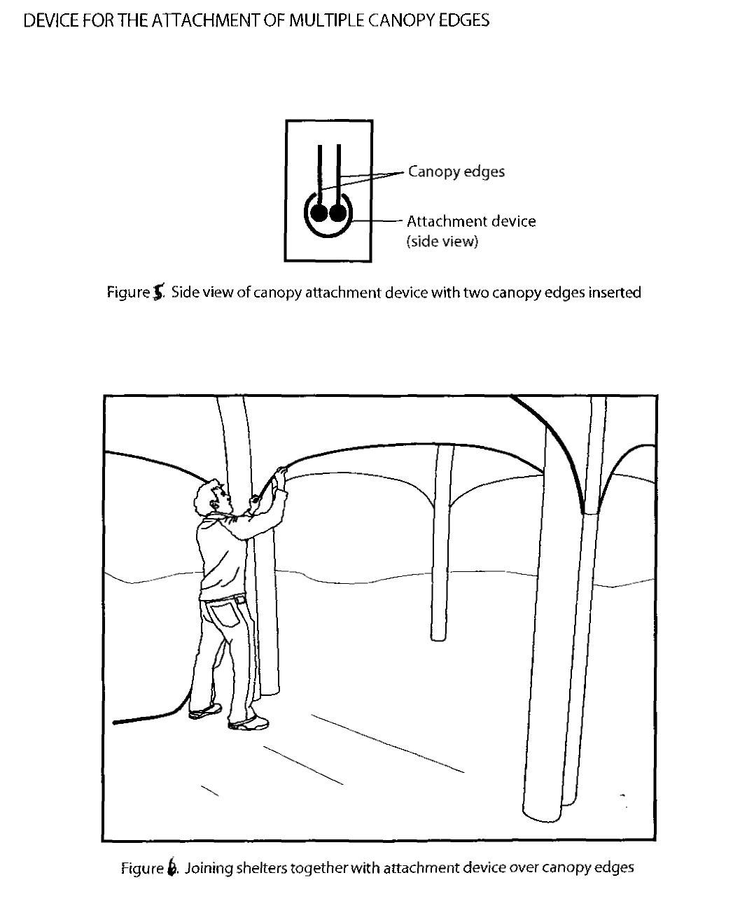

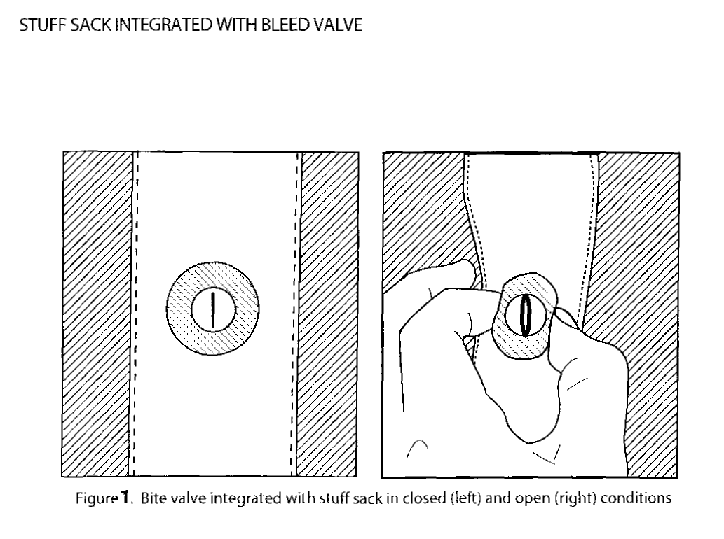

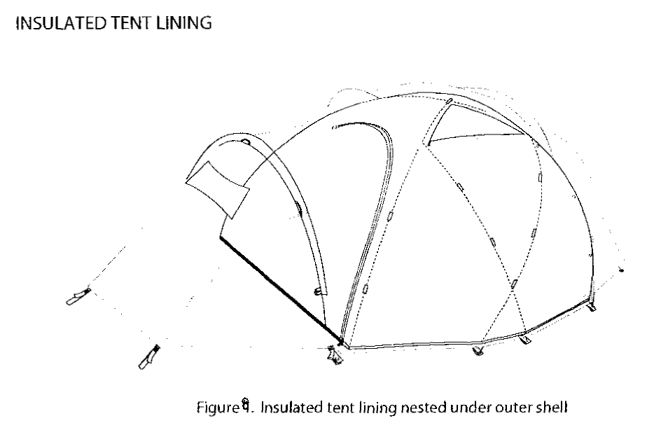

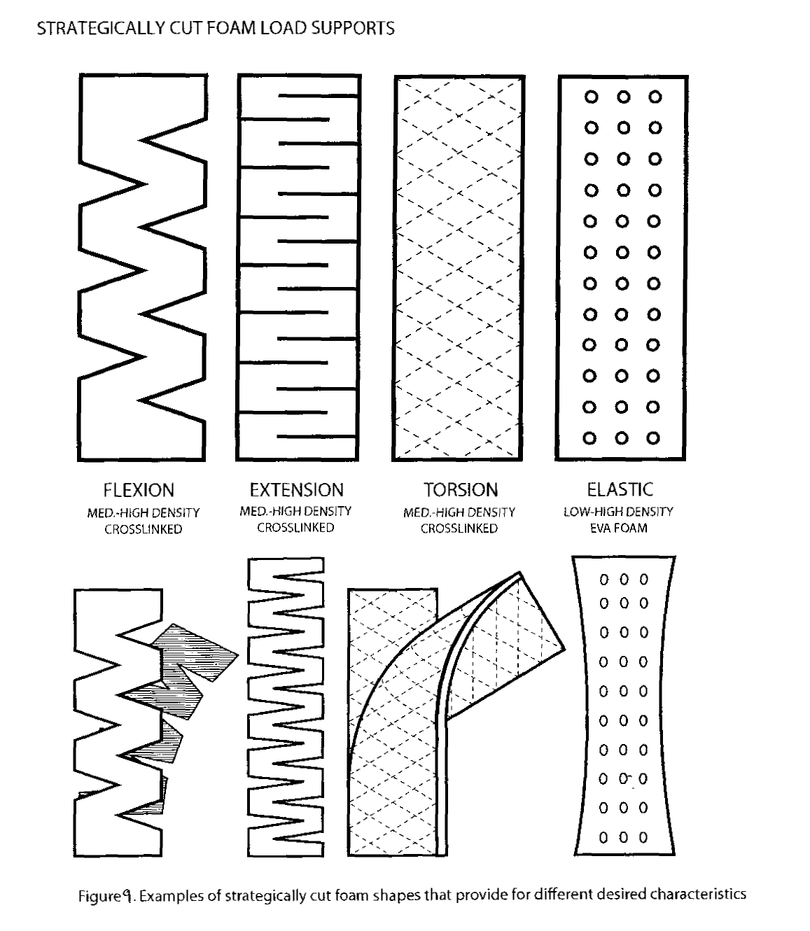

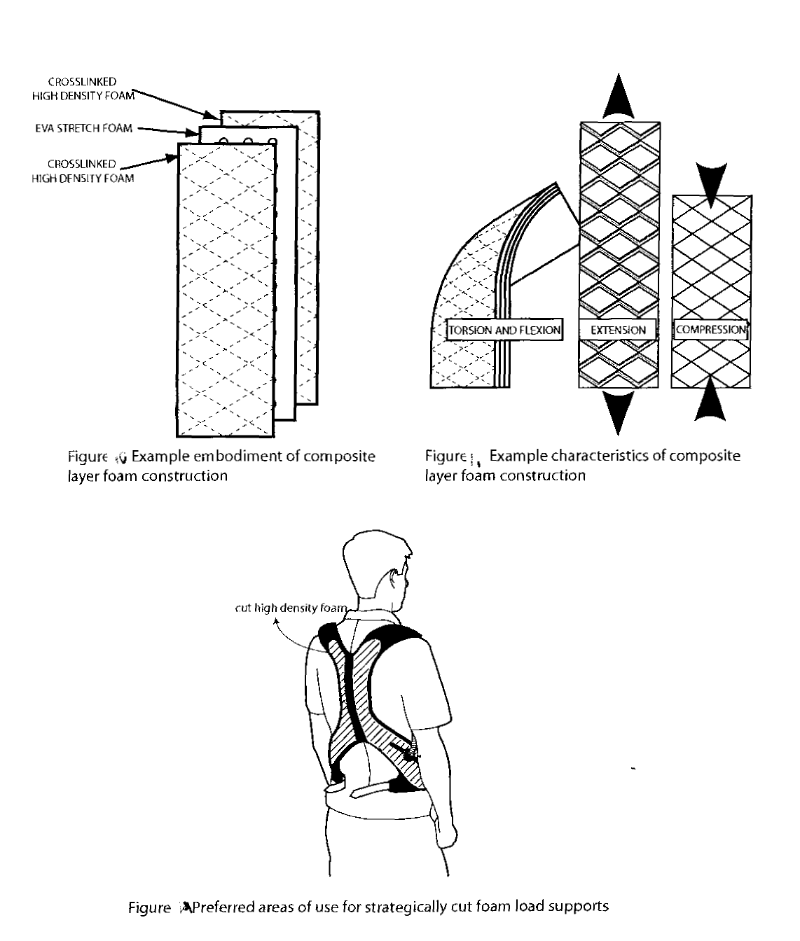

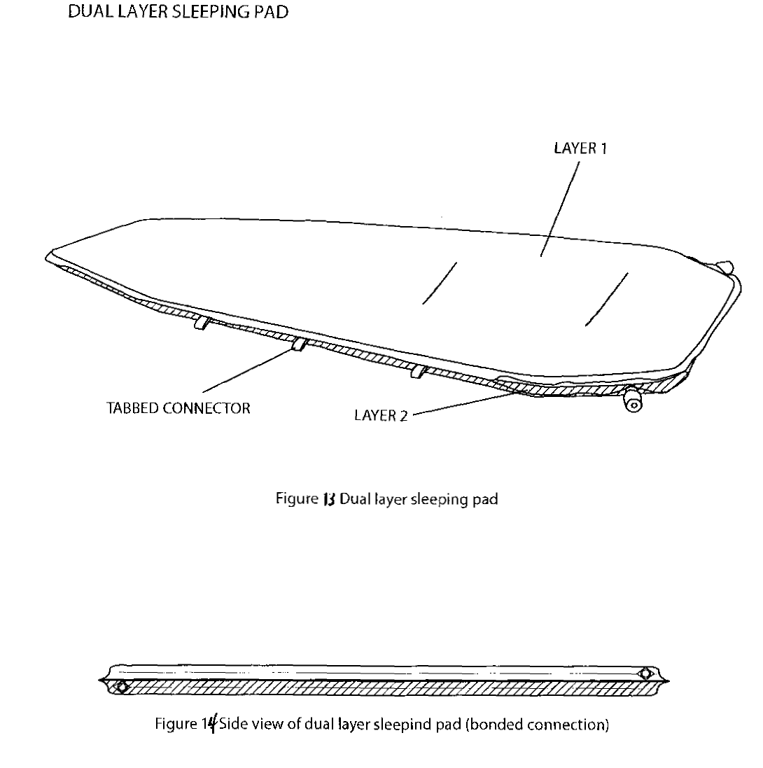

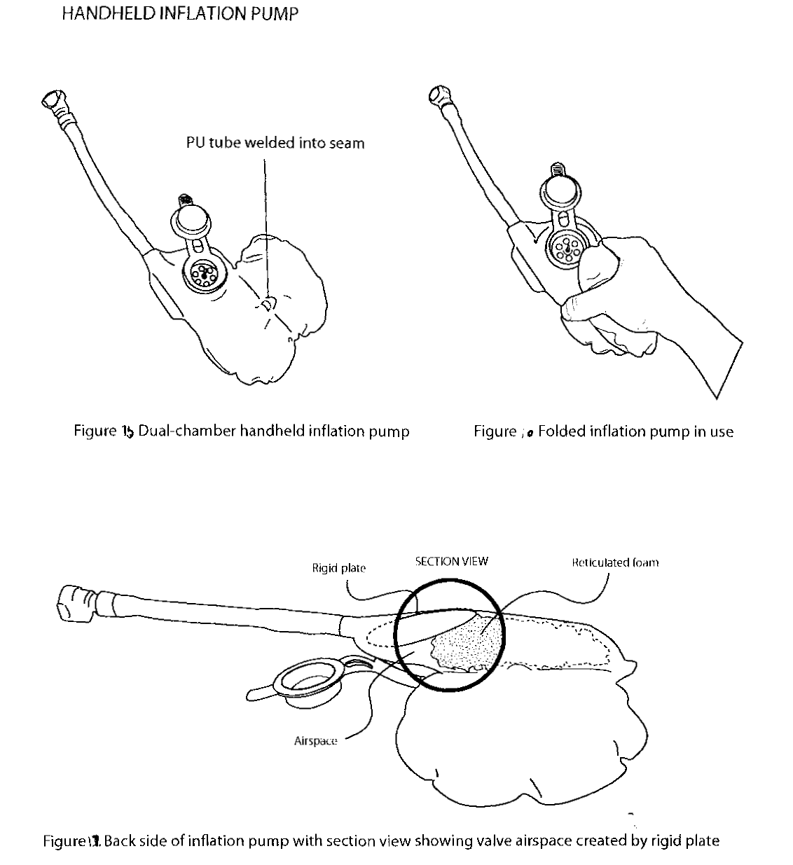

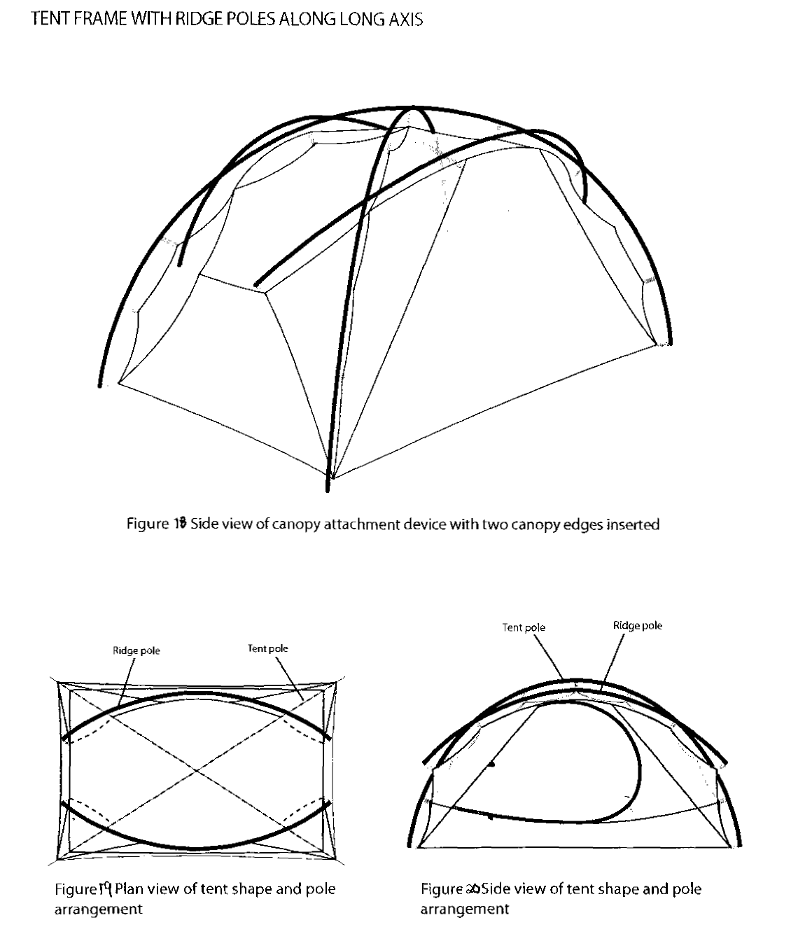

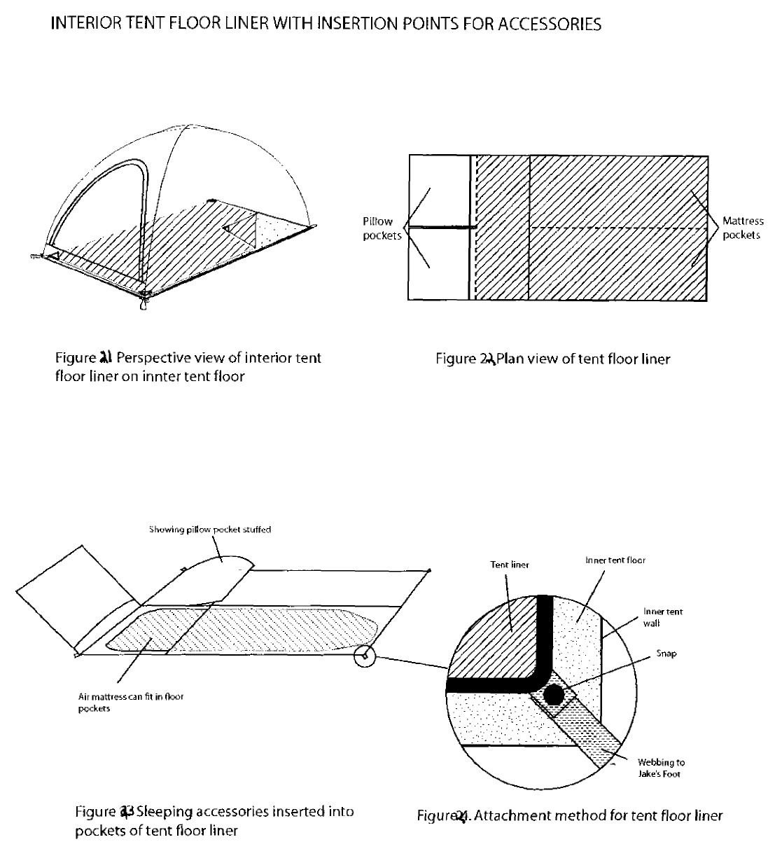

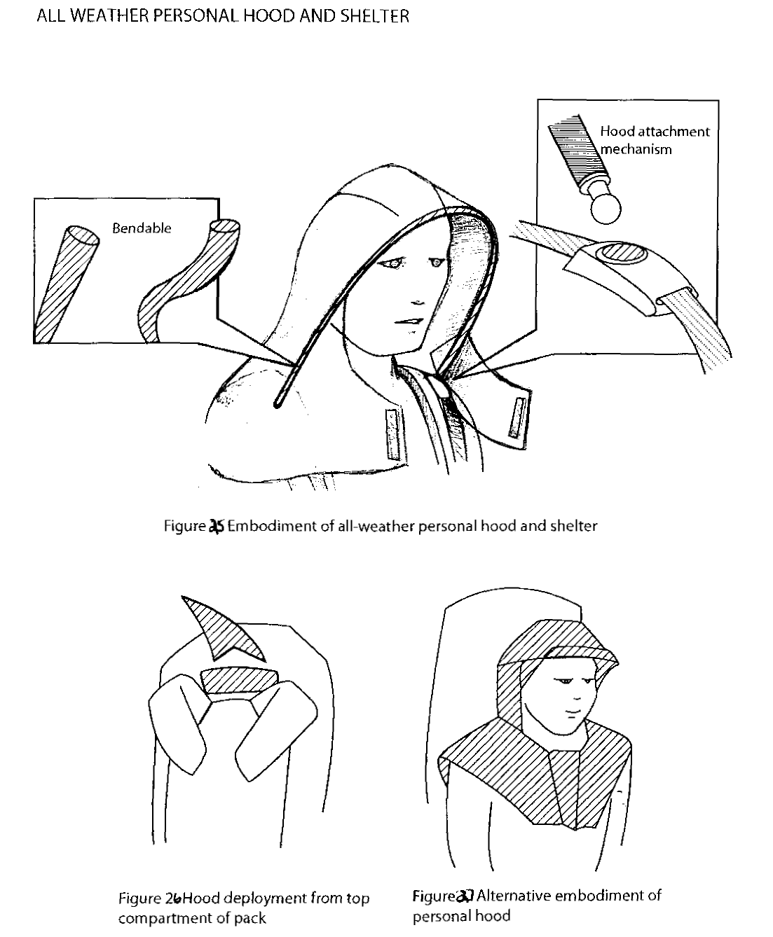

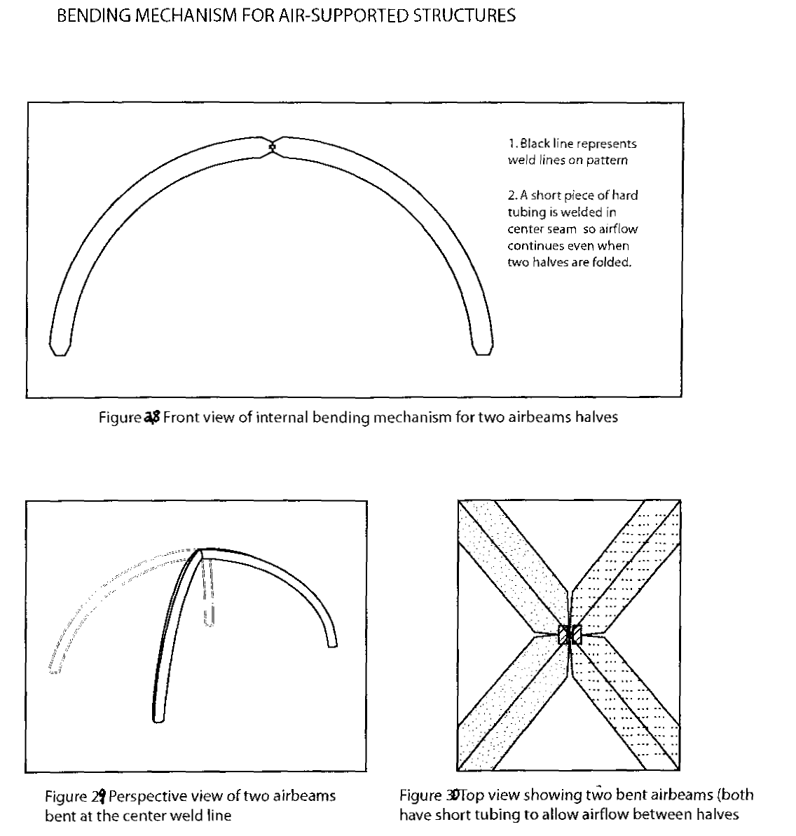

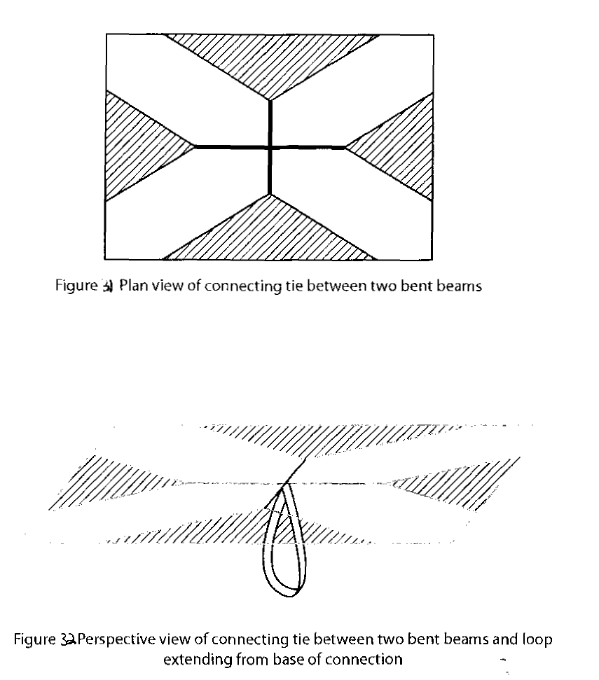

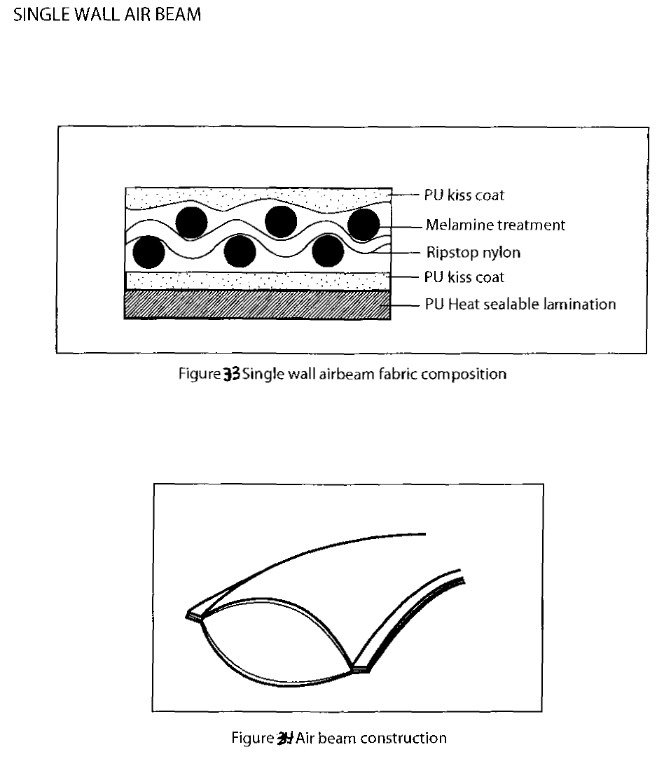

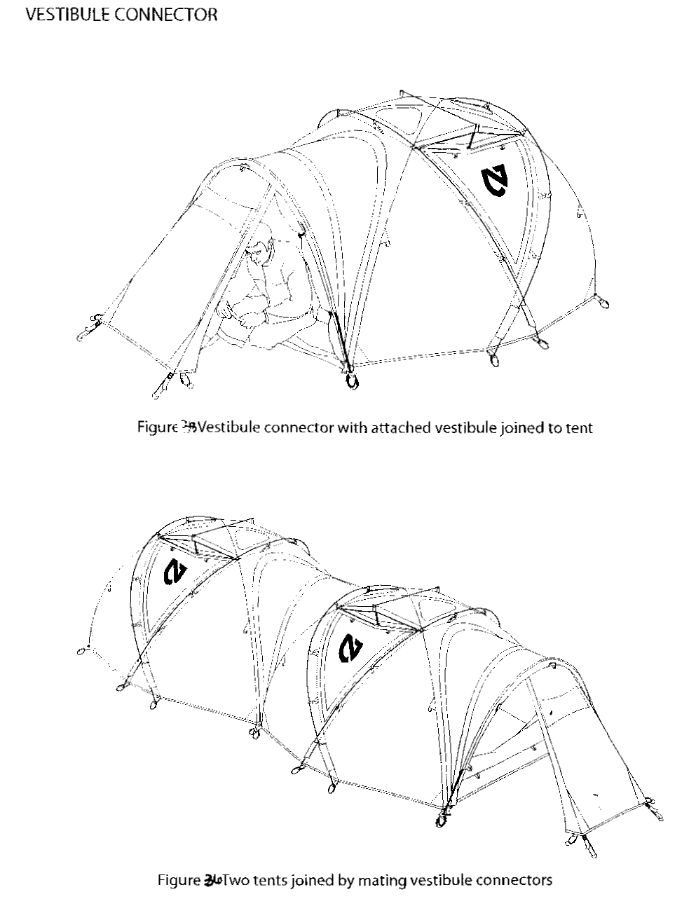

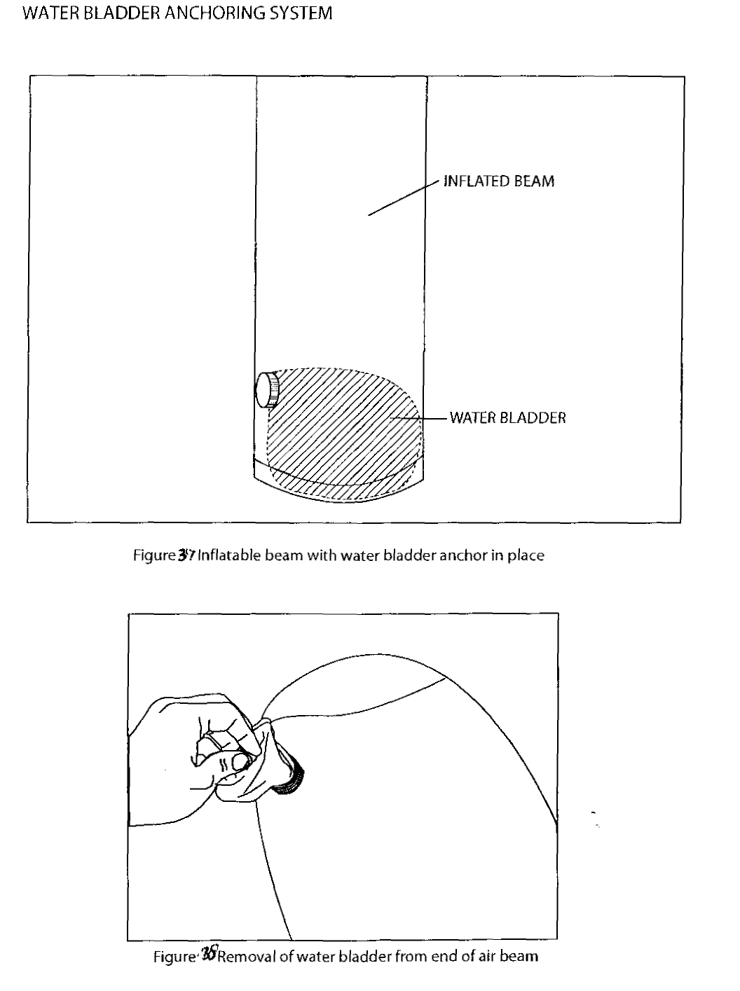

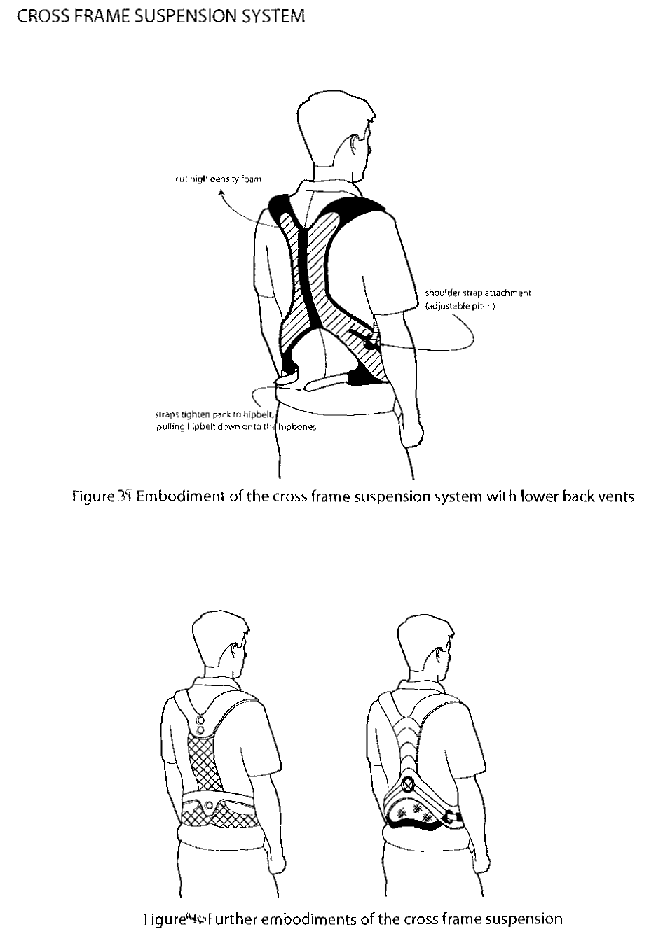

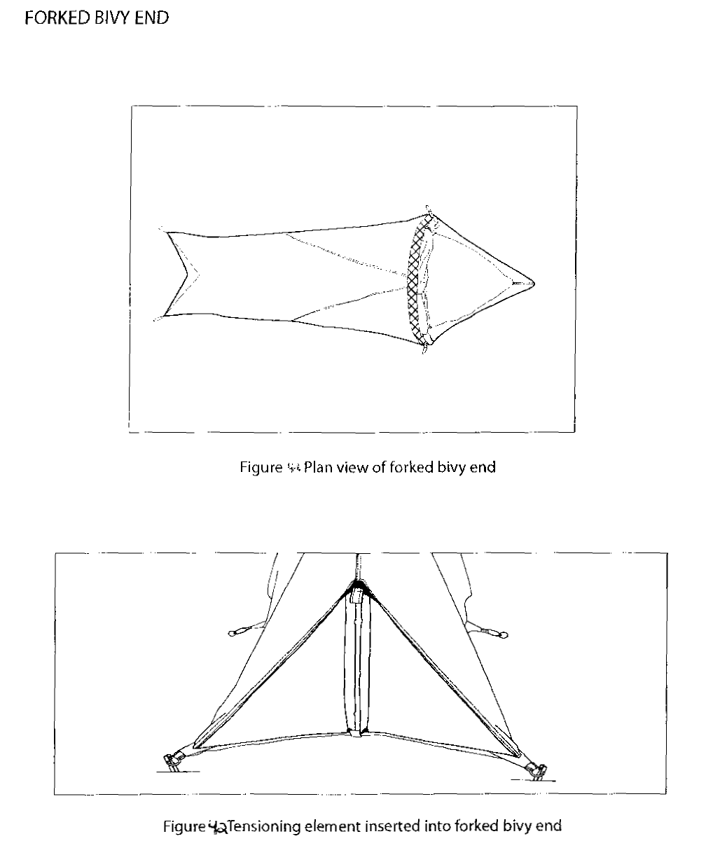

### CROSS-REFERENCE TO RELATED APPLICATIONS

This application claims priority to PCT Application Number PCT/US2008/057682 filed on Mar. 20, 2008 entitled “Out Door Equipment” and Provisional Patent Application No. 60/895,771 filed on Mar. 20, 2007 entitled “Outdoor Equipment”, which is incorporated fully herein by reference.

### Connection Joint For Inflatable Beams (Airbeam Sockets)

### Description of Prior Art

Inflatable beams are often used as structural elements in tents, shelters, or canopies. When numerous inflatable beams are used, it is undesirable to have separate inflation points for each beam due to increased setup time. Although long lengths of inflatable beams can be folded to create two useable sections (halving the number of inflation points), no device exists to accommodate these types of inflatable beams for a given geometry or beam arrangement. For structures that use multiple inflatable beams, it is also difficult to orientate and fix the beam arrangement to achieve the desired configuration.

### Brief Summary of the Invention

The present invention comprises a connection joint that allows inflatable beams to be joined in various configurations without additional fasteners. Beams are inserted into receptacles that orientate the shape to a desired manner. The invention allows inflatable beams to be patterned in a planar fashion without any additional curvature. The joint then configures the beams to create stable structures and reduce the number of inflation points.

The connection joint is preferably composed of a rigid molded material but may also be molded from a number of elastomeric substances in order to achieve the desired configuration.

In one embodiment, individual tubular members are simply inserted into receptacle sockets such that each socket contains precisely one tubular member.

In another preferred embodiment, long tubular members, capable of being bent at the midpoint, are inserted into the joint such that each tubular member is folded at the receptacle socket but contains two legs originating from the socket ends that extend downwards. This configuration allows for a dome configuration to be composed from an even number of beams, 2n, where n refers to the number of total number of tubular members that are bent in half at the receptacle socket. To create a rigid structure, a minimum of two tubular members are bent in half to create four beams. A plurality of receptacle sockets may be used to attain a more circular dome shape. This arrangement allows the number of inflation points to be halved from standard configurations.

### Ergonomic Segmented Pack (Arthropod Pack Concept)

### Description of Prior Art

Load carrying packs are used in activities as varied as running, hiking, cycling, climbing, skiing, and snowboarding that move and twist the body in different ways. However, current pack designs do not accommodate for the varying degrees of bending and movement for distinct areas of the back. In particular, the majority of articulation occurs in the lumbar region of the spine whereas bending in the thoracic region is generally more limited. Pack loads are also most efficiently carried as close to the body as possible and at the center of mass, where loads may be transferred from the shoulders and back closer to the hips.

While some existing pack designs provide a means to distribute loads to the hip/waist region, there are no known packs that allow for differing amounts of articulation along the spinal column.

### Brief Summary of the Invention

This invention comprises an anatomically segmented pack separated into thoracic, lumbar, and hip regions to account for the differing degrees of articulation and support required by each section. This layout allows each respective part of the pack to move in an unconstrained manner with the body when performing a variety of activities. Pack loads may be discretely compartmentalized by region to further enable the greatest articulation at the lumbar area and more rigid support in the thoracic area.

Loads are transferred from the shoulders and back of the user to the hips using a load bearing element. This anatomically articulated layout also helps pull the pack load closer to the upper body to more efficiently carry the load.

In one embodiment, the segmented layout is represented by an integrated shoulder strap, thorax harness, articulated lumbar support, and load bearing hip belt. The shoulder straps cross over the top of each shoulder and join into a one piece “Y-shaped” construction proximal to the center line of the shoulder blades. The shoulder straps are preferably angled along the back to provide clearance for shoulder blade movement. This clearance may be facilitated by a lacing or tightening system to further draw in the shoulder straps to the center of the back. From the bottom of the one-piece shoulder strap, the thorax portion of the pack extends in two opposite directions under each respective shoulder blade, around the side of the body, and is fastened to the extended end of the shoulder strap located on the front side of the user. The thorax portion of the pack is effectively fixed to the ribcage, holding the upper pack to the body. When shoulder straps are pulled tight, the load is transferred in the perpendicular direction, pulling the pack inwards, closer to the body. The lumbar portion of the pack is flexibly attached to the upper portion of the pack via a load bearing element such as a cylindrical piston. This element carries the bulk of the load under expansion and contraction, and serves to dissipate any moment forces created during relative rotations of the shoulder and back. The lumbar region allows the full range of spinal movement while carrying weight to the hips using an anatomically shaped hip belt that bears the load of the pack. Each end of the hip belt is adjustably fastened at the user's front.

In another embodiment, the shoulder straps also extend over the top of each shoulder, but immediately connect to form a broad one-piece construction that extends over the entire upper and lower back region of the user, including the shoulder blades. The thorax portion of the pack again extends under each arm and wraps around the ribcage. The ends of the thorax straps are fastened to the respective ends of each shoulder strap where straps can be pulled tight to draw the pack load closer to the body. A load bearing cylinder works similarly in this embodiment to carry the load to the hips.

### Device for the Attachment of Multiple Canopy Edges

### Description of Prior Art

Portable shelters can be combined to create a larger protected space available for use. Many current shelters do not provide for any attachment means to one another; shelters are simply set up beside each other to create a sense of shared space. Thus when one shelter is moved in any manner, whether inadvertent or not, adjacent shelters must also be moved accordingly.

More importantly, the distinct canopy edges that result from adjacent standing shelters creates an unprotected gap which is highly undesirable during rain, snow, heavy sunlight, or other similar conditions.

### Brief Summary of the Invention

The object of invention is a device that is used to reversibly join together two distinct canopy edges of adjacent shelters to create a single canopy edge. This enables a strong edge link to be made when connecting adjacent shelters. The formation of a single canopy edge also forces rain, snow, and other elements to exit at the two extreme endpoints of the canopy edge, rather than along the entire length of canopy.

The device is preferably a long flexible piece of extruded material that holds the two edges in place. The length of the device is exactly the length of the edge that is held together so that no gaps occur when joining the two adjacent sides together.

Since the canopy attachment device is flexible, it is able to conform to any curvatures or shapes that comprise the canopy edge.

In one preferred embodiment, the cross-section is a ‘C’-shape. The small opening at the top enables the canopy edges to be inserted into the device. It is preferable that the canopy edges have a piping of greater cross-sectional area relative to the fabric itself so that when both edges are inserted into the connection device, no slippage of fabric will occur out of the device.

It is envisaged that the user will stand at one extreme end of the canopy and insert the two adjacent edges into the device. The device is then pushed along the length of the edge such that two adjacent edges can be inserted into another section of the device. This action is repeated until the entire canopy edge resides within the canopy attachment device.

### Stuff Sack Integrated With Bleed Valve

### Description of Prior Art

Stuff sacks that store items such as sleeping bags, bivy sacks, tents, and jackets are often difficult to compress to a smaller volume. Smaller volumes are extremely desirable since these types of items are frequently used in situations where space is limited and items must be hand-carried. In existing stuff sack designs, it is difficult to fully remove excess air because the materials that are compressed trap air within the recesses of fabric folds. Current stuff sacks require the user to roll and compress material from one specified end while simultaneously forcing air out. If this method for sack compression is not followed, air is easily trapped in the stuff sack.

To remedy this problem, some prior art have used deflate valve attachments. However, this solution is not ideal due to both the cost of the device and the bulk of the mechanism.

### Brief Summary of the Invention

The object of invention is a stuff sack that contains a one-way valve consisting of a rubber seal with a single slit to allow air out but no air in. The bleed valve allows easy removal of air from a stuff sack without necessitating a difficult method or order of fabric compression. One-way bite valves may also be used to finely tune and regulate the air contained within an inflated object. For example, small quantities of air may be expelled using the bite valve.

The one-way bleed valve may be located in any variety of locations within a stuff sack. Since air trapped between multiple layers of fabric and material often has a difficult time escaping, a bleed valve located in certain strategic locations may allow air to diffuse without use of excessive force to compress the entire contents of the bag.

In one preferred embodiment, the bleed valve may be represented by a rubber insert with a slit cut into it. The valve expels air when the slit is opened by gently squeezing the valve sides with the fingertips. When the valve is untouched, the slit remains closed and impervious to air and other fluids.

### Insulating Tent Liner (Cheez)

### Description of Prior Art

Tents are often used in cold or extreme weather conditions where warmth is difficult to sustain. Due to excessive weight and cost, insulating tent liners have rarely been incorporated into existing designs. Since tents are often hand-carried long distances before use, weight and packability are issues of importance. Thus many materials traditionally used for insulation are not appropriate for tent applications.

Although lightweight insulation materials such as Aerogels exist, these solutions are generally not cost-effective nor easily manufactured into the desired form of use. An insulating tent liner that provides substantially increased warmth while still being breathable, packable, manufacturable, lightweight, and cost-effective is desirable.

### Brief Summary of the Invention

This invention consists of the application of heat-reflective fabric as a waterproof breathable tent liner that aids in insulation while still being cost-effective and easily manufacturable. The proposed insulating tent lining provides a 10-20% increase in warmth above normal tent conditions. The heat-reflective fabric is a multi-layer lamination composed of an outer fabric, membrane, ultra-thin aluminum, and lining. An ultra-thin (a few nanometers thick) coating of aluminum is added to the breathable membrane to reflect up to 75% of the body's warmth. The resulting laminate is completely waterproof, windproof, and highly breathable.

The insulated lining is custom fit to the interior geometry of the tent or shelter such that a minimum of interior volume is sacrificed. The liner is fixed in place by attachment to internal tent poles. In one preferred embodiment, the interior lining is entirely removable such that the tent shell and insulating lining are composed of two separate pieces. The lining has strategically placed openings so that Velcro straps located on the internal tent poles may be inserted in the openings to reversibly fix the lining to the interior tent surface.

For two-piece constructions, a number of attachment methods may be used. One preferred fastening method uses hook and loop enclosures to secure the inner lining to the outer shell structure. Other acceptable fasteners may include buttons, snaps, zippers, ties, or hooks. Numerous attachment points may be used along the interior surface to ensure a precise fit of the insulating lining and inner shell structure.

To enable easy passage to and from the tent or shelter, details such as door zipper openings may also be included in the insulating tent liner.

### Strategically Cut Foam Load Supports

### Description of Prior Art

Conventional pack supports, called stays or framesheets, are used to support and transfer loads. Typically, one or two aluminum stays are used to transfer weight to the hipbelt so users can more efficiently carry loads. Stays are usually formed from rods, bars, or tubes. Used independently or in combination with stays, packs may also include stiff plastic inserts called framesheets for load support.

The problem with traditional stays and framesheets is that they are rigid in nearly all directions, despite the user's twisting and bending motions. Since packs are worn for a variety of activities such as running, climbing, skiing, and mountaineering that involve lateral movements, twisting, elongation, compression, and complex bending of the body, rigid supports are not desirable.

While more complicated mechanical devices have been created to address this issue, it has been at a higher manufacturing cost due to additional parts, materials, and complexity of assembly.

### Brief Summary of the Invention

The present invention consists of strategically cut foam supports that provide desired characteristics of strength, stability, and mobility in load-bearing packs. Foam supports are preferably placed along specific sections of the pack to function as stays, framesheets, or supports.

Strategically cut foam provides mobility or immobility to different sections of the pack depending on the desired degree of articulation. Strategic cuts also allow or prevent lateral movement, twisting, elongation, compression, and bending.

Multiple embodiments of strategically cut foam may be created depending on the particular property that is desired. For instance, high flexion can be attained by removing small triangular notches from alternating vertical edges of a strip of foam. Extension is achieved when alternating vertical slits are cut into opposite edges of foam. Torsionally-soft but compressively rigid elements are created by scoring a diamond pattern in the top and bottom surfaces of foam. The use of EVA foam with multiple circular holes cut along both columns and rows of a strip improves the elastic properties of foam structures.

In accordance with further aspects of the invention, composite suspensions systems may be created using layered foams, fabrics, and rigid elements, which in combination create desired traits of strength, stability, and mobility. Foam members may be constructed with multiple laminated or bonded layers with different properties to achieve a variety of material characteristics. For instance, one such layered construction may be composed of a layer of EVA stretch foam sandwiched between two layers of cross-linked high density foam. Constructions such as these enable ease of movement during torsion and flexion, extension, and compression. Other possible configurations may contain two or more foam elements in the middle surrounded by two or more elements of differing densities or stretch directions.

Layered foam construction may be used in any aspect of load supporting structures to ensure that rotational or bending movements are not restricted in any manner due to rigidity or inflexibility of material construction. In particular for shoulder and hip-carried loads by users, it is preferable to use these layered materials in areas of the upper torso that are subject to twisting and non-linear movement. These areas include the top surface of each shoulder, the anterior side of the back comprising the thoracic vertebrae, and left and right regions of the hip bone immediately adjacent to the lumbar region.

### Dual Layer Sleeping Pad

### Description of Prior Art

Current inflatable sleeping pads are only composed of a single layer of soft foam bonded to a fabric cover. To decrease the feel of any rough terrain beneath the pad, more air is blown into the mat. However, heavily inflated sleeping pads are generally more uncomfortable to use. If the air is reduced in sleeping pads to increase user comfort, it is difficult to avoid any irritations caused by irregularities on the ground beneath the pad.

A new sleeping pad is needed that enables both an initial greater inflation level to smooth out rough terrain and a secondary inflation level that can be adjusted for user comfort. The pad should not weight or pack into a greater volume than existing single layer sleeping pads.

### Brief Summary of the Invention

The object of the current invention consists of a sleeping pad that is composed of two discrete layers. Each layer can be inflated to a different hardness level. This enables the lower sleeping pad to be inflated to a greater degree to minimize the feel of miscellaneous debris, rocks, or uneven terrain when sleeping. The upper layer may be inflated to a lesser degree to maximize cushioning and comfort for the user.

In one preferred embodiment, both layers of the sleeping pad are composed of open cell foam such that when the valves are opened, the foam self-inflates by absorbing ambient air. Valves for each respective layer allow different hardness levels to be attained. The two layers of the sleeping pad may be connected by small welded tabs located along the outer edges of the layers, or any other similar fastening means. The welded tabs ensure that the two layers cannot significantly shift or be separated from one another during use. However, alternative semi-permanent fasteners such as Velcro may also be used in order to enable division of the dual layers for pack purposes when the sleeping pad is not in use.

The inflation valves preferably allow air to travel in to the inner foam cavity when twisted open. Conversely, when the valves are twisted shut, no air can enter or escape the cavity. Valves for each respective layer may be located on the same end of the sleeping pad in order to facilitate a quicker setup time.

The material used on the outer surface of the lower layer is preferred to be more durable and abrasion-resistant since this layer is the primary ground contact. Furthermore, a softer micro-fiber fabric is preferred for the top surface of the upper layer since this surface is the primary user-contact area.

### Hand-Held Inflation Pump

### Description of Prior Art

Handheld inflation pumps currently comprise a piston which travels along the length of a hollow cylinder when push or pulled by a handle. A connection valve used to transfer the expelled air to the object of inflation is located on the opposite end from the handle.

Since the cylinder housing and pump components are generally composed of plastic or similar incompressible materials, these pumps do not pack to a smaller size. Especially in situations where space is limited and items are hand-carried, it is extremely inconvenient to carry such a hard, discrete item of this particular shape and size.

Moreover, continuous pumping using this mechanism is fatiguing due to the nature of the required pumping action.

### Brief Summary of the Invention

This invention relates to a lightweight handheld inflation pump. This pump is small, light, and packable relative to current pump alternatives due to its soft-body foam construction. The pump consists of a combination valve used to draw in and expel air, and a dual-chamber inflation body. The two chambers are folded together and squeezed when the valve is open to ambient air to provide an outflow of air to the attached valve connector.

A greater inflation volume may be attained through a two-chamber construction compared to single chamber designs. The dual-chamber shape provides an ergonomic fit to the hand to optimize pumping actions. A main chamber is connected via a small length of tubing to an adjacent secondary chamber. This method of construction allows the secondary chamber to folded back upon the primary chamber into an ergonomic hand-held shape so that when the entire unit is compressed or squeezed, a greater air volume is dispelled towards the valve.

Within the two chambers, lightweight material such as open-cell reticulated foam may be used to draw in air. A combination valve is preferred to minimize the number of attachments and simplify the assembly. Air is completely expelled from the reticulated foam when the valve is sealed shut and the chambers are squeezed. When the valve is open, air is drawn in through the chambers and out towards the exit valve. A rigid plate partially supporting the top of the reticulated foam is welded to the inner surface of the back fabric to preserve and enhance airspace for the valve.

The air that is drawn in from the combination valve is preferably expelled through an external port that is sealed in an airtight manner so that one end resides within the main chamber and the opposite end extends outwards. The port preferably contains an attachment point that may be used to connect to inflatable objects.

### Tent Frame With Additional Ridge Poles (Losi Shape)

### Description of Prior Art

The geometry and structural stability of tent frames is determined by its pole configuration. Although there exist many ways of arranging tent and ridge poles, current designs do not fully optimize factors including interior volume, structural rigidity, weight, and packing size.

Conventional ridge poles are placed along the short axis of a tent raising the head height at extreme ends of the tent. However, the interior volume of the tent is not maximized since tent walls are often pitched at a steep angle in this arrangement. In an alternative arrangement, tents that contain a single ridge pole along the long axis often do not have strong structural stability.

### Brief Summary of the Invention

The current invention consists of a tent supported by a unique pole configuration that increases the available interior space and provides greater structural rigidity than previous tent pole configurations while minimizing weight.

Two ridge poles located along the long axis of the tent are used to raise the inner ceiling height of the tent and add strength to the entire structure. The ridge poles are inserted into grommets or similar attachment points located proximal to the anterior and posterior portions of the tent. They are positioned in a symmetrical manner on either side of the tent, spanning the side panel lengths of the tent canopy.

In a preferred embodiment, two outer tent poles are crossed in a diagonal manner over the exterior of the tent. One pole end is anchored into a grommet or similar-type attachment point, and is then bent to curve around the top of the tent. The other pole end is anchored to an identical grommet or similar-type attachment point on the diagonally opposite corner. This same configuration is mirrored for a second outer pole on the opposite side of the tent.

The shape of the desired ridge pole along the tent may be specified by a ridge pole sleeve that is shaped and offset at a desired location. Ridge poles can be inserted through these sleeves to tension or curve the entire pole length to a specified manner. Alternately, hook fasteners can also be used to reversibly attach the ridge poles to the outer canopy of the tent.

Ridge poles may be mounted and angled in a manner to provide greater stability and rigidity to the tent structure. The angle of attachment also affects the amount of interior space available within the tent. Ridge poles that have their maximum peak located above the canopy line will increase the total volume inside the tent as well as the inner standing height immediately within the inner edges of the walls.

Both outer poles and ridge poles may be made of a variety of materials including aluminum, aluminum alloys, plastics, carbon fiber, fiberglass, etc.

### Interior Tent Floor Liner With Insertion Points For Accessories (Pawprint)

### Description of Prior Art

Tent floor interiors are difficult to keep clean since the space is often dirtied by boots or family pets. The ability to remove the floor and wash it adds to the longevity of the tent floor and increases the overall comfort of the interior space. An interior footprint allows for softer materials because water proofing is not needed. This extra insulating floor layer can also serve as a system to keep inflatable mattress pads from sliding around, or create pockets to be filled with clothing as pillows.

### Brief Summary of the Invention

The object of invention is to provide a removable interior floor lining for a tent or similar type of shelter that can be detached for cleaning. The floor lining is used to protect the shelter floor from dirt and contamination and is constructed from washable materials to allow easy cleaning. Another object of invention is to provide an interior floor lining which allows insertion of various sleeping accessories such as sleeping pads or pillows into preformed pockets. The insertion of sleeping pads or pillows into pockets prevents gaps and subsequently areas of cold air from forming due to shifting of weight, especially during sleep. Since interior pockets closely match the dimensions of commercially available sleeping pads, minimal positional shifting occurs.

In one preferred embodiment of invention, a floor lining, preferably made of a brushed micro-fiber or material of similar comfort and insulation properties, is shaped to the same geometry as that of the tent floor. Attachment points in the form of snap-enclosures, Velcro tabs, or other similar devices are used to fix the corners and edges of the floor lining to that of the tent.

In a further preferred embodiment of invention, a seam is used to divide the floor liner into separate sections so that multiple sleeping pads can be inserted into the lining. At the top end of the floor liner, extra material is folded over and sewn so that clothes or other cushioning articles can be inserted to form a pillow.

The entire floor lining is detachable from the main shelter floor and can be machine washed for easy cleaning. Floor linings can be made in any number of shapes specific to tent floors. The materials used for the lining may be of differing thickness and insulation properties as well depending on the needs of the user.

### All-Weather Personal Hood And Environment (Airbeam Canopy)

### Description of Prior Art

Hoods found on outerwear garments are often used to protect users from inclement weather or extreme conditions. However, if a particular item of outerwear is desired during activity but stored deep within a pack, it can be difficult to retrieve the desired item.

Hoods and jackets may also be bulky and restrict movement, especially if they are constructed of multiple fabric and insulation layers. If only a simple shell is needed for weather protection, a separate jacket/hood may be excessive.

### Brief Summary of the Invention

The object of the current invention is an all-weather hood that can be easily deployed from a pack to protect the user from wind, rain, snow, sun, and insects or to give the user privacy.

In one preferred embodiment, the hood is stored in the top portion of the pack, separate from the primary pack load. The hood compartment may be opened and closed with a number of fastening devices.

Upon opening the hood compartment, a personal shelter is deployed that encompasses a hood connected to fabric that partially covers and protects the upper torso, shoulder, and upper back. The hood preferably may be customized to suit a desired fit or amount of head coverage. Customization of the hood may be accomplished by sewing bendable wire into the seams of the hood. This allows for the curvature of the leading edge of the hood to be individually tuned to the user's needs.

The hood shape may be embodied as a half arc, covering the majority of the head. Bendable wire, if utilized, may be reversibly attached to a separate bracket or slot integrated near the upper shoulder portion of the hood. In another embodiment of the hood shape, flexible wires span across the brim of the hood such that the curvature can be changed to a desired shape. The brim may extend beyond the user's face to increase protection from wind, rain, and snow.

In yet another embodiment, the hood shape may also be supported by air-filled members that lay flat within the pack cavity when not in use. Air may be inserted via a hand held pump integrated within the pack to create a semi-rigid structure to better protect the user.

Preferred embodiment of the back, shoulder, and torso portion of the hood consists of a split construction whereby left and right sections of material extend over the shoulder and join at the midpoint of the upper torso. Velcro or a similar quick enclosure method may be used to fasten to the two sections of material together.

Materials used for the hood consist of lightweight waterproof fabrics that may be also coated in UV-protectors or mosquito repellant.

### Bending Mechanism For Airbeams (Sausage Link Airbeams)

### Description of Prior Art

Air-inflated beams are used to create a variety of structures including tents, shelters, and hangars. Given a structure composed of multiple airbeams, it is undesirable to have a large number of inflation points due to complexity of assembly. Although long lengths of airbeam can be manufactured, a device is needed that enables bends to be achieved at specified locations.

### Brief Summary of the Invention

The object of invention is a mechanism that allows controllable buckling of a single wall airbeam. The invention enables the creation of multiple arcuate structures to minimize inflation points, increasing the convenience and speed of set up.

In one preferred embodiment of the concept, a bend is created at the midpoint of an airbeam by welding a short piece of hard tubing in the center seam. Two small horizontal weld lines are first made on the center seam directly above and below where the tubing is inserted. To seal off the remainder of the center seam, vertical seals may be made from the upper horizontal weld to the upper edge of the structure and from the lower horizontal weld to the lower edge of the structure. Thus the center seam only contains a small to insert tubing in the horizontal direction.

Tubing material may be composed of either rigid or semi-rigid materials such as rubbers or thermoplastics as long as air passage is able to occur. Depending on the fabric used to construct the geometric structure, a variety of bonding processes may be utilized. It is preferable that for TPU-coated fabrics, welding processes such as impulse sealing or radio frequency welding are used in order to create clean weld lines.

The tube connection in the center seam allows air to flow from one half of the airbeam to another, enabling inflation of the entire volume. Airflow through the system occurs even when the airbeam is bent tightly. Multiple airbeams utilizing this bending mechanism may be combined by tying together structures at the bent midpoint to create different configurations. In addition, structures may be bent at any preferred angular orientation ranging from nearly linear configurations to almost no separation of the beam ends.

### Single Wall Airbeams

### Description of Prior Art

Current materials used to make inflatable airbeams are not dimensionally stable in an isotropic manner. The pattern direction and orientation has a significant effect on resulting material characteristics. In fabrics that stretch on the bias direction, patterning direction and orientation must be consistent, leading to a high level of material waste since it becomes difficult to closely pack pattern pieces.

Other designs for inflatable airbeams use a two-piece construction comprised of an outer non-resilient sleeve contained an inner resilient bladder, for example, made of rubber-inner tubes. The use of a double wall construction uses more material and thus is heavier than single-walled members. Manufacturing processes for this method of construction also tend to be more complex, adding additional cost to the overall structure.

### Brief Summary of the Invention

This invention consists of an inflatable airbeam constructed with melamine-treated ripstop nylon fabric. The fabric is treated on the top and bottom surfaces with a light kiss-coat of polyurethane (PU). The top coat is laminated with an additional PU layer so that the fabric can be overlap-welded to form a desired shape or geometry.

While regular non-treated nylon fabric allows a great deal of bending and flexibility when stretched along the bias, the melamine coating allows the structure to be dimensionally stable. This minimizes differences in material characteristics due to pattern direction and orientation and allows more predictability during patterning.

This construction method has useful applications in numerous areas, including the construction of inflatable recreational structures, shelters, and tents. In particular, the high strength and rigidity of the material allows an extremely stable structure to be created that resists torsional bending.

### Forked Bivy End (Swallow Tail Bivy End of Gogo)

### Description of Prior Art

Bivy sacks are used as solo shelter systems that protect sleeping bags and have an expanded area of shielded headspace to block bad weather and insects. In some bivy shelters, small suspension systems (poles, hoops, stiffened wires, beams) lift the fabric off the user's face, and shelters are able to achieve full enclosure. Bivy sacks and shelters aim to minimize size and weight.

Condensation is typically a problem with many bivy sacks. Warm air that escapes from the user's body often collects on the inside fabric walls, resulting in dampness. Further compounding the problem is the fact that bivy ends are usually draped over the user's feet, impeding air circulation. Although good circulation helps minimize condensation, current bivy designs do not enable this to occur.

### Brief Summary of the Invention

The object of invention is a forked end geometry for a bivy shelter that may be vertically tensioned with no additional stakes or guyouts. The bivy end does not need to be tensioned for the shelter to be used.

Tensioning the bivy end increases ventilation by exposing a greater inner surface area to circulated air. Thus the top of the bivy foot end is raised above the sleeping bag or user in a manner that maximizes the available interior space without using excess materials or exterior components.

Any tensioning element can be used, as long as it is the appropriate length. For the natural environment of use, rods or sticks are easily obtained to fit in the given space. Given that tensioning elements are easily found, no external rods, poles, or shafts are included for this purpose, allowing smaller pack dimensions and weights to be achieved.

The footprint geometry consists of a vertex located at the centerline of the bivy end. From this vertex, two edges extend outwards in opposite directions at an acute angle. These edges intersect with the respective side lengths of the bivy shelter to form the basic footprint geometry.

At the vertex of the forked geometry, a tensioning element (such as a rod or stick) may be inserted to give an increased inner volume compared to current bivy shelters. The insertion of a tensioning element results in an apex at the top vertex that extends downwards in opposite directions to the endpoints of each angled edge. The geometry bears resemblance to the forked swallowtail shape. In one preferable embodiment, a grommet or similar fastener is attached to the bottom vertex point to allow one end of the tensioning element to be fixed to a point on the ground while the upper end supports the end of the bivy shelter.

### Vestibule Connector (Moki's Vertical Vestibule Zip)

### Description of Prior Art

Vestibules are used on tents to provide a sheltered entrance, additional storage space, or protected work area during inclement weather. Existing designs only allow a full vestibule to be attached to a tent without any additional options. Depending on external conditions, it may be desirable to have different sizes of space attached to the basic tent, ranging from a smaller vestibule attachment to an additional adjoining tent. This option is not currently available in existing designs.

### Brief Summary of the Invention

This invention comprises a connector piece for a tent that enables either the attachment of a full vestibule or the linkage of two like tents with one another.

The preferred attachment method of the connector piece consists of a full zippered length on one edge of the connector that joins the corresponding zipper length of the tent door. A zipper is also sewn to the entire length of the opposite edge of connector piece. Unlike most conventional zipped attachments, zippers are located on the vertical plane of the tent.

The opposite edge of the connector is the mating point for either a full vestibule or an additional connector piece attached to a like tent. Mating edges have opposite types of zipper teeth to enable meshing of the two zipper sides. If zipper sides are patterned such that an ‘A’ and ‘B’ side exist for two meshing zipper sides, the zipper teeth for the tent door may be considered side ‘A’, the linking edge for the connector piece may be side ‘B’, the opposite edge of the connector may be side ‘A’, and the linking edge for the vestibule or second connector piece may be side ‘B’.

The connector piece also allows the interior volume to be expanded, especially when considering the slope of conventional tent walls. Volume increases are primarily related to an increase in head height extending from the tent door.

The connector piece is preferably made of the same waterproof, windproof, and breathable material as the main body of the tent. However, color scheme of the connector piece may be chosen to aid in attachment of the vestibule or secondary connector.

### Water Bladder Anchoring System

### Description of Prior Art

In standard inflatable structures, the inner cavity is filled with air. Weighting and support usually occurs externally with stakes, guy-outs, sandbags, or weights. However, sandbags and weights are neither easily transportable nor readily available. Though stakes and guyouts are relatively light, they tend to be located within the user workspace and can be hazardous obstacles to avoid.

### Brief Summary of the Invention

This invention relates to an anchoring system that uses removable water bladders to internally weigh down inflatable structures. Water bladders are inserted into internal cavities and enclosed with an air-tight cap to prevent any fluid from leaking out. Bladders are preferably filled with a volume of water that serves as a mass to immobilize a structure.

The object of invention especially relates to inflatable structures which contain large internal cavities. In this case, a large valve opening can serve dual-purposes. A substantial volume of air can be quickly expelled through a dump valve. The large valve opening also allows the water bladder to be easily removed for cleaning.

In one preferred embodiment, a water bladder insert is welded onto a bladder such that fluids that are poured into the top of the valve are collected within the interior of the bladder. The water bladder insert may be inserted within the interior surface of a threaded valve to make an airtight seal. The threaded valve preferably contains exterior threads such that a threaded end cap may be fastened atop the assembly after the bladder is filled. Airtight and watertight seals may be ensured by the usage of gaskets, o-rings, and other sealing components on areas such as the threaded end cap and the water bladder insert.

### Cross Frame Suspension System (X Frame Chassis)

### Description of Prior Art

Conventional suspension systems for backpacks use hip belts that wrap around the lumbar region and fasten around the hips to transfer loads closer to the user's center of mass. Hip belt systems are often poorly ventilated in the lumbar region and susceptible to sliding movement when supporting high loads.

More complex support and suspension structures use multi-piece constructions or molding processes that require high manufacturing costs for the specified frame geometry, ventilation cutouts, and fasteners. Frame geometries such as these also carry loads directly to the lumbar region of the spine, which may lead to pain and fatigue with use. Even support systems that have explored various suspension configurations utilize frame components that require load support from the lumbar region to the base of the sacrum. Problems with poor ventilation are also common for designs that fully cover the user's shoulder and back with large frames or cushioning elements.

### Brief Summary of the Invention

The present invention consists of a crossed suspension member that branches off above the lumbar region of the spine, distributing the load evenly to the hips. Using a crossed configuration better spreads the load to the hips, alleviating pressure on the lower back, and allowing air circulation throughout the same region.

The crossed configuration more closely follows the contours of the back and spine, resulting in a frame that is more flexible and can move with the rotations of the hips and shoulders during activity. The cross-shaped configuration wraps around a user's individual anatomy to create a close fit so that the load can be carried close to the body.

In one embodiment of the invention, a flexible support link spanning the approximate length of the thoracic vertebrae connects a pair of diagonally extending shoulder straps and a hip belt. The hip belt preferably splits in opposing directions above the lumbar vertebrae region of the spine such that a left section and right section are created. The hip belt contains a left section and right section that are attached to each other by a connecting means which is capable of being adjusted within a predetermined range such that the hip belt can be adjusted to fit individual user geometry. The shoulder straps extend over the shoulder of the wearer and continue downwards across the front of the body and underneath the arms, reaching an attachment point adjacent on each side to the central lumbar region.

The shoulder strap attachment is preferably located on an adjustable diagonal pitch that allows the strap length to be adjusted accordingly to a desired load distribution and pack height. Additional adjustment straps on the left and right sections extending from the anterior side of the hip belt can be pulled taut to tighten the pack to the hip belt. Tightening these straps also acts to pull the hip belt down to the hip bones, appreciably decreasing the tension that must be supported by the shoulder straps.

Another embodiment of the crossed configuration allows adjustment of the combined hip belt and shoulder strap system through a connecting element based at the junction of the left and right split section of the hip belt. Separate adjustment straps are aligned along each section of the hip belt as it wraps around the user's hips. Tightening of the left and right sections of the hip belt at the front of the hip belt draws the load closer towards the hips.

1. A connection joint for inflatable air beams, comprising:
a rigid member having a plurality of openings, said rigid member configured and shaped to join a plurality of inflatable air beams into a predetermined configuration, each said inflatable air beam including a first end, a second end, and a midsection extending from said first end to said second end, said rigid member including a plurality of receptacle regions, each of said plurality of receptacle regions configured for receiving an end region of an inflatable air beam or a midsection region of an inflatable air beam.
